(19) United States
(12) Patent Application Publication
(10) Pub. No.: US 2026/0186153 A1
(43) Pub. Date: Jul. 2, 2026

(54) METHOD AND APPARATUS OF LEARNING AND/OR USING LIFETIME MODEL OF GLOBAL NAVIGATION SATELLITE SYSTEM NAVIGATION MESSAGES

(71) Applicant: MEDIATEK INC., Hsinchu City (TW)

(72) Inventor: Kun-Tso Chen, Hsinchu City (TW)

(73) Assignee: MEDIATEK INC., Hsinchu City (TW)

(21) Appl. No.: 19/392,156

(22) Filed: Nov. 18, 2025

Related U.S. Application Data
(60) Provisional application No. 63/741,392, filed on Jan. 2, 2025.

(51) Int. Cl. G01S 19/48

(52) U.S. Cl. CPC G01S 19/48

(57) ABSTRACT

A method of learning a lifetime model of global navigation satellite system (GNSS) navigation messages includes: obtaining GNSS navigation data, and analyzing the GNSS navigation data to learn the lifetime model, wherein the lifetime model includes information indicative of a lifetime behavior of at least one data set of a GNSS navigation message.

### CROSS REFERENCE TO RELATED APPLICATIONS

This application claims the benefit of U.S. Provisional Application No. 63/741,392, filed on Jan. 2, 2025. The content of the application is incorporated herein by reference.

### BACKGROUND

The present invention relates to Global Navigation Satellite System (GNSS) signal processing, and more particularly, to a method and apparatus of learning and/or using a lifetime model of GNSS navigation messages.

The GNSS is often described as an “invisible utility”, and is so effective at delivering two essential services—time and position—accurately, reliably and cheaply that many aspects of the modern world have become dependent upon them. Each satellite of the GNSS is equipped with a highly precise atomic clock. When four or more satellites are in view, a GNSS receiver can measure the distance to each satellite by estimating the signal transmission time delay from the satellite to the receiver. From these measurements, GNSS-embedded device can derive its own position and synchronize to the accurate GNSS system time.

Navigation data message is required for the GNSS receiver to determine its position. Therefore, the GNSS receiver must receive navigation data from satellites for a positioning fix. When the signal condition is bad, the GNSS receiver must wait until the data is collected. Take a GPS L1 coarse/acquisition (C/A) receiver for example, one bad subframe costs at least 30 seconds (i.e., time of one frame) to achieve Time to First Fix (TTFF).

A conventional solution is using an assisted GNSS (AGNSS) server, which provides navigation data message for the GNSS receiver to speed up TTFF. However, the AGNSS server is not always available. For example, the GNSS receiver is not connected to Internet, such as in the Non-Terrestrial Networks (NTN) application, or the user is at sea or on the mountain. Even the GNSS receiver is connected to Internet, the AGNSS server may be too busy to provide aiding service sometimes.

Thus, there is a need for an innovative scheme which enables a GNSS receiver to achieve TTFF under a condition that the required navigation data are not available from satellites or AGNSS servers.

### SUMMARY

One of the objectives of the claimed invention is to provide a method and apparatus of learning and/or using a lifetime model of GNSS navigation messages.

According to a first aspect of the present invention, an exemplary method of learning a lifetime model of GNSS navigation messages is disclosed. The exemplary method includes: obtaining GNSS navigation data from which its transmission time from the satellites can be derived; and analyzing the GNSS navigation data and the transmission time data to learn the lifetime model, wherein the lifetime model includes information indicative of a lifetime behavior of at least one data set of a GNSS navigation message.

According to a second aspect of the present invention, an exemplary GNSS signal processing method with lifetime model aiding is disclosed, which includes: storing local GNSS navigation data; maintaining a lifetime model of GNSS navigation messages, wherein the lifetime model includes information indicative of a lifetime behavior of at least one data set of a GNSS navigation message; determining validity of the local GNSS navigation data according to the lifetime model; and in response to the local GNSS navigation data being validated by using the lifetime model, performing a GNSS signal processing function with the aid of the local GNSS navigation data.

According to a third aspect of the present invention, an exemplary electronic device is disclosed. The exemplary electronic device includes a storage device and a processing circuit. The processing circuit is configured to obtain GNSS navigation data from which its transmission time can be derived, analyze the GNSS navigation data and the time data to learn a lifetime model of GNSS navigation messages, and store the lifetime model in the storage device, wherein the lifetime model includes information indicative of a lifetime behavior of at least one data set of a GNSS navigation message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device with a lifetime model learning capability according to an embodiment of the present invention.

FIG. 2 is a diagram illustrating a GPS LNav structure according to the GPS satellite signal specification, Interface Control Document (ICD).

FIG. 3 is a diagram illustrating characteristics of navigation data carried by subframes required by a positioning fix according to an embodiment of the present invention.

FIG. 4 is a diagram illustrating lifetime of GPS LNav data according to an embodiment of the present invention.

FIG. 5 is a diagram illustrating a first live navigation data generator design according to an embodiment of the present invention.

FIG. 6 is a diagram illustrating a second live navigation data generator design according to an embodiment of the present invention.

FIG. 7 is a flowchart illustrating a method of learning and updating a lifetime model of GNSS navigation messages according to an embodiment of the present invention.

FIG. 8 is a diagram illustrating an operation of sampling the data and updating the lifetime model according to an embodiment of the present invention.

FIG. 9 is a diagram illustrating a joint model approach using different navigation messages broadcasted by the same satellite according to an embodiment of the present invention.

FIG. 10 is a diagram illustrating an edge device for performing a lifetime model aided GNSS signal processing function according to an embodiment of the present invention.

FIG. 11 is a diagram illustrating a scenario in which the local GNSS navigation data are used to aid the GNSS signal processing function according to an embodiment of the present invention.

FIG. 12 is a diagram illustrating distribution of constant bits within each GPS LNav.

FIG. 13 is a diagram illustrating a frame synchronization circuit of a GNSS receiver according to an embodiment of the present invention.

FIG. 14 is a diagram illustrating a search pattern (i.e., local replica) with different sizes in different periods of the frame synchronization according to an embodiment of the present invention.

FIG. 15 is a diagram illustrating a first correlator design according to an embodiment of the present invention.

FIG. 16 is a diagram illustrating a second correlator design according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

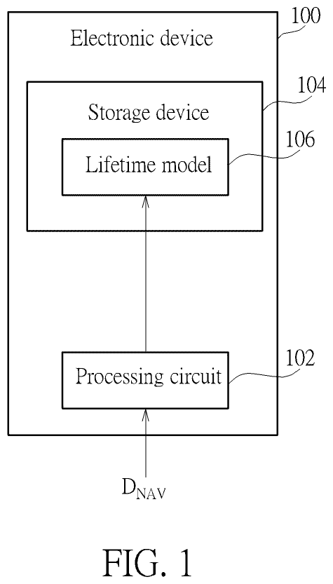

FIG. 1 is a diagram illustrating an electronic device with a lifetime model learning capability according to an embodiment of the present invention. For example, the electronic device 100 may be implemented in an edge device such as a portable device (e.g., smartphone, wearable device, or tablet) equipped with a GNSS receiver or an in-vehicle device equipped with a GNSS receiver. For another example, the electronic device 100 may be implemented in a cloud server such as an AGNSS server. In this embodiment, the electronic device 100 includes a processing circuit 102 and a storage device 104. For example, the processing circuit 102 may be implemented using a general-purpose processor, and the storage device 104 may be implemented using a memory device. The processing circuit 102 is configured to obtain GNSS navigation data D_{NAV}, analyze the GNSS navigation data D_{NAV}, Which consists of transmission time data DTime, to learn a lifetime model 106 of GNSS navigation messages, and store the lifetime model 106 into the storage device 106 for later use, wherein the lifetime model 106 includes information indicative of a lifetime behavior of at least one data set of a GNSS navigation message. The GNSS navigation messages from which the lifetime model 106 is learned may be received from any GNSS system (e.g., GPS, Galileo, BeiDou, GLONASS, NavIC, QZSS, or SBAS).

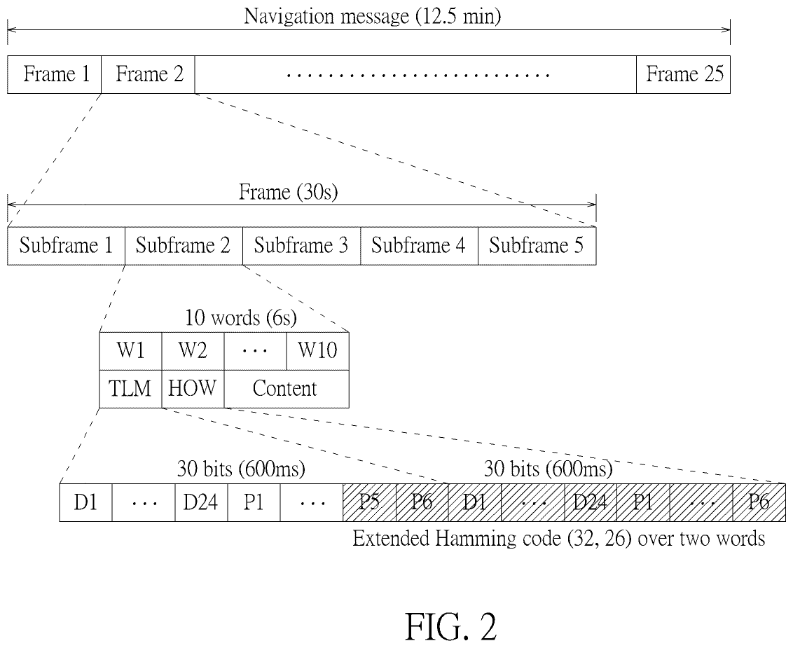

In this embodiment, the navigation data carried by one GNSS navigation message may be classified into data sets based on the lifetime. For better comprehension of technical features of the present invention, the following assumes that the lifetime model 106 is generated for GPS legacy navigation messages (LNav) transmitted on the L1 C/A channel. FIG. 2 is a diagram illustrating a GPS LNav structure according to the GPS satellite signal specification, Interface Control Document (ICD). One navigation message contains twenty-five 1500-bit frames (labeled by “Frame 1”, “Frame 2”, . . . , “Frame 25”), each made up of five 300-bit subframes (labeled by “Subframe 1”, “Subframe 2”, “Subframe 3”, “Subframe 4”, “Subframe 5”). Each subframe contains ten 30-bit words (labeled by “W1”, “W2”, . . . , “W10”), each having 24 data bits (labeled by “D1”, . . . , “D24”) and 6 parity bits (labeled by “P1”, . . . , “P5”, “P6”). One word is protected by using a (32, 26) Hamming code. The 1st word W1 is a Telemetry (TLM) Word that is common to all subframes in the same frame. The 2^{nd} word W2 is a Handover Word (HOW) that is common to all subframes in the same frame. The first three subframes 1-3 of one frame contain information about ephemeris and clock of the satellite. The last two subframes 4-5 of one frame contain information about almanac of satellites. The navigation message is transmitted continuously and synchronized to a common GPS system time. The time tag of GPS system time is transmitted in the navigation data message. For example, the data fields, TOW (time of week) and WN (week number), are transmitted in D_{NAV} to indicate the corresponding GPS system time epoch at the leading edge of the defined data bit in D_{NAV}. Once the TOW and WN are received, the electronic device 100 can observe how D_{NAV} changes as GPS system time goes. On the other hand, the corresponding GPS system time can also be obtained from AGNSS server.

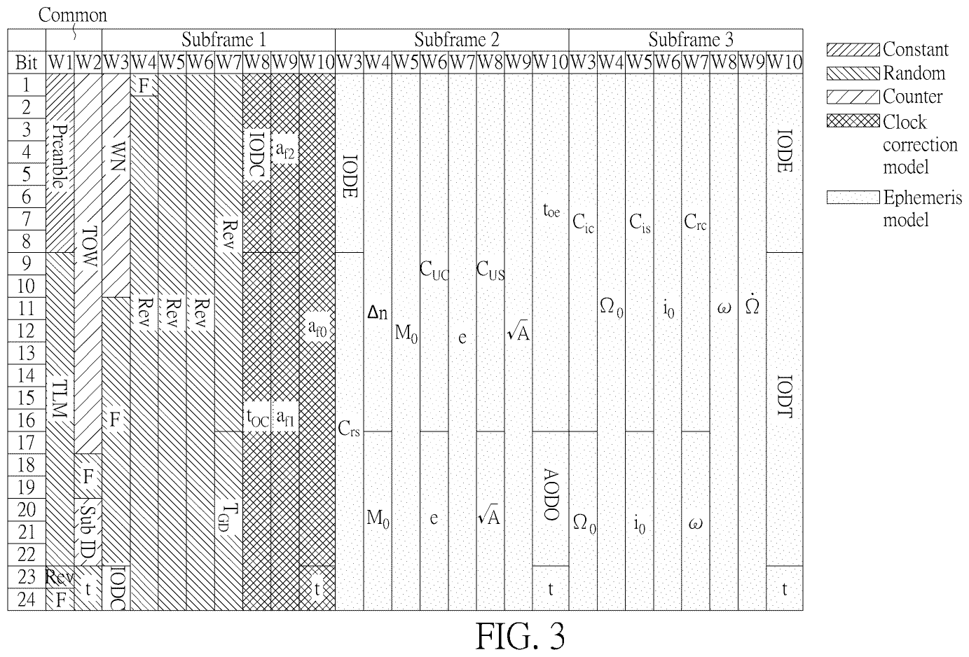

The navigation data content changes as GNSS system time. For example, some data bits are always constants, some are counter as GNSS system time, and some are constants in a period of GNSS system time. The navigation data carried by subframes of one frame may be classified into different data sets according to such inherent data characteristics. FIG. 3 is a diagram illustrating characteristics of navigation data carried by subframes 1-3 required by a positioning fix according to an embodiment of the present invention. In accordance with characteristics of the navigation data, the navigation data carried by subframes 1-3 may be classified into an “Always Constant” data set, a “Constant in Lifetime” data set, a “Counter” data set, a “Random” data set, etc. For example, the “Always Constant” data set may include a preamble pattern. The “Constant in Lifetime” data set may include model parameters such as parameters of the clock correction model and parameters of the ephemeris model, the “Counter” data set may include GNSS system time (e.g., time-of-week count TOW, a time tag to indicate the GPS system time in a week corresponding to the specified data bit edge) and subframe index (e.g., subframe ID code), and the “Random” data set may include data whose changepoints and values may not be predictable by the ICD such as satellite signal integrity status flags, transmission time group delay, and reserved bits. However, these are for illustrative purposes only, and are not meant to be limitations of the present invention.

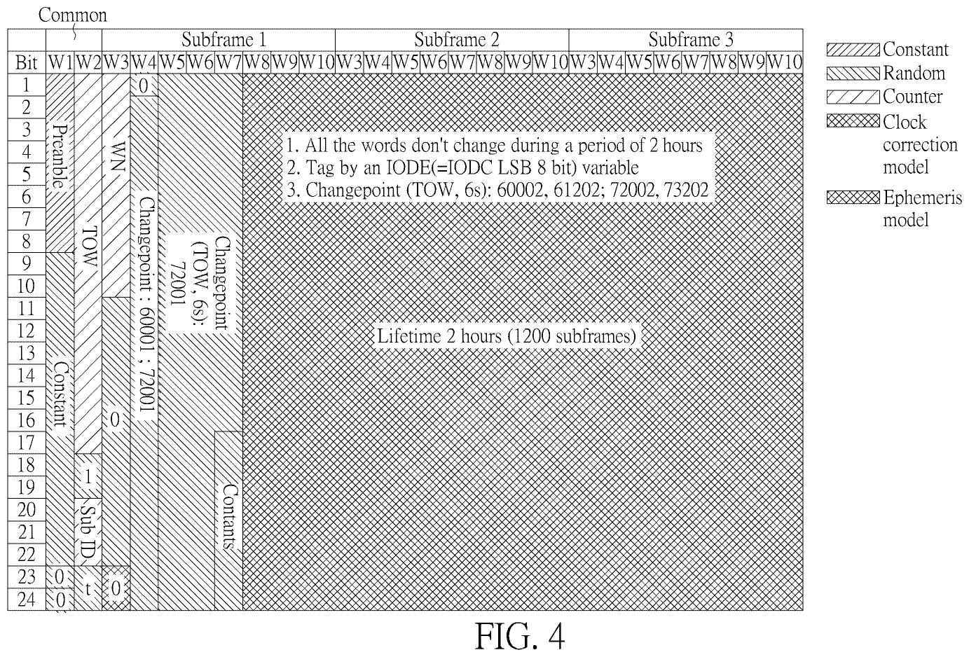

Different data sets may possess different lifetime behaviors. FIG. 4 is a diagram illustrating lifetime of GPS LNav data according to an embodiment of the present invention. Real broadcast data from the GPS satellite are captured and analyzed. As shown in FIG. 4, the common word W1 includes constant data, the common word W2 includes predictable data, and words W3-W10 in subframes 1-3 include predictable data, unpredictable data, and data that change every two hours (1200 subframes). Different GNSS signal processing functions may require different data sets obtained from subframes. For example, ephemeris and clock information are required in a cold start positioning fix. In this embodiment, the lifetime model 106 may include information indicative of a lifetime behavior of each data set classified in a GNSS navigation message. For example, the lifetime model 106 may indicate the relationship between GNSS system time (or local time, which can be synchronized to the GNSS system time with some relationship) and changepoint of data content. Specifically, the GNSS navigation data D_{NAV} include a sequence of received GNSS navigation messages, and the processing circuit 102 performs offline/online changepoint detection upon the sequence of received GNSS navigation messages to identify each changepoint in a data set and a time instant of the detected changepoint, where a lifetime period of the data set may be defined by time instants of two consecutive changepoints of the data set, and the time instant of each changepoint may be measured with reference to time information (e.g., GNSS system time or local time).

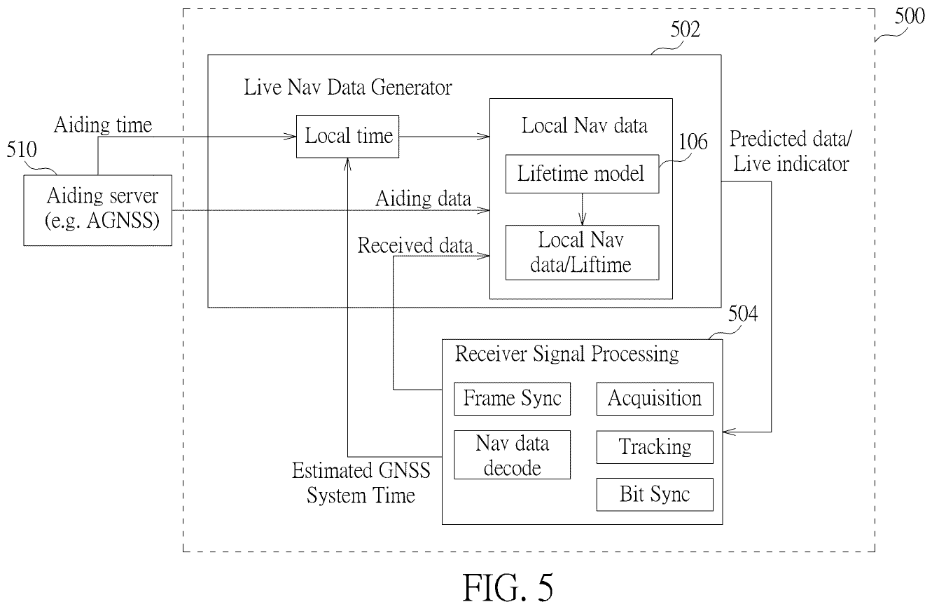

The lifetime model 106 may be learned on a cloud server (e.g., AGNSS server) or an edge device (e.g., user device), depending upon actual application requirements. FIG. 5 is a diagram illustrating a first live navigation data generator design according to an embodiment of the present invention. In this embodiment, a live navigation data generator circuit (labeled by “Live Nav Data Generator”) 502 and a receiver signal processing circuit (labeled by “Receiver Signal Processing”) 504 are both implemented in an edge device 500. For example, the edge device 500 may be a portable device (e.g., smartphone, wearable device, or tablet) or an in-vehicle device. The edge device 500 can communicate with an aiding server 510. For example, the aiding server 510 is a cloud server such as an AGNSS server. The aiding server (e.g., AGNSS server) 510 may be a network-based system that provides aiding data (or aiding data and time) to GNSS receivers to improve their performance, especially in challenging environments like urban areas or indoors. For example, the aiding server (e.g., AGNSS server) 510 may regularly receive and store GNSS navigation data, where the GNSS navigation data are gathered from reference stations with clear satellite visibility. The receiver signal processing circuit 504 may be a part of a GNSS receiver. The live navigation data generator circuit 502 may include the electronic device 100 shown in FIG. 1. In other words, the live navigation data generator circuit 502 is capable of analyzing the GNSS navigation data D_{NAV} to learn the lifetime model 106. The edge device 500 can use the lifetime model 106 to assist the receiver signal processing circuit 614 in one or more GNSS processing functions (e.g., frame synchronization, navigation data decoding, acquisition, bit synchronization, carrier recovery, and timing recovery).

In some embodiments of the present invention, the live navigation data generator circuit 502 obtains the GNSS navigation data D_{NAV} from the receive signal processing circuit 504. Specifically, the edge device 500 may receive at least a portion (i.e., part of all) of the GNSS navigation data D_{NAV} transmitted from at least one satellite.

In some embodiments of the present invention, the live navigation data generator circuit 502 obtains the GNSS navigation data D_{NAV} from the aiding server 510. Specifically, the edge device 500 may receive at least a portion (i.e., part or all) of the GNSS navigation data D_{NAV} from a cloud server.

In some embodiments of the present invention, the live navigation data generator circuit 502 obtains the GNSS navigation data D_{NAV} from the receive signal processing circuit 504 and the aiding server 510. Specifically, the edge device 500 may receive a first part of the GNSS navigation data D_{NAV} transmitted from at least one satellite, and may further receive a second part of the GNSS navigation data D_{NAV} from a cloud server. For example, the first part and the second part of the GNSS navigation data D_{NAV} (e.g., received data and aiding data) that are provided from different sources may be fused and then used for learning the lifetime model 106.

In some embodiments of the present invention, the live navigation data generator circuit 502 obtains the GNSS system time from the receiver signal processing circuit 504.

In some embodiments of the present invention, the live navigation data generator circuit 502 obtains the GNSS system time (e.g., aiding time) from the aiding server 510.

In some embodiments of the present invention, the live navigation data generator circuit 502 obtains the GNSS system time from the receiver signal processing circuit 504 and the aiding server 510. Specifically, the edge device 500 may fuse the aiding time and estimated time from the received signals to use or learn the lifetime model 106.

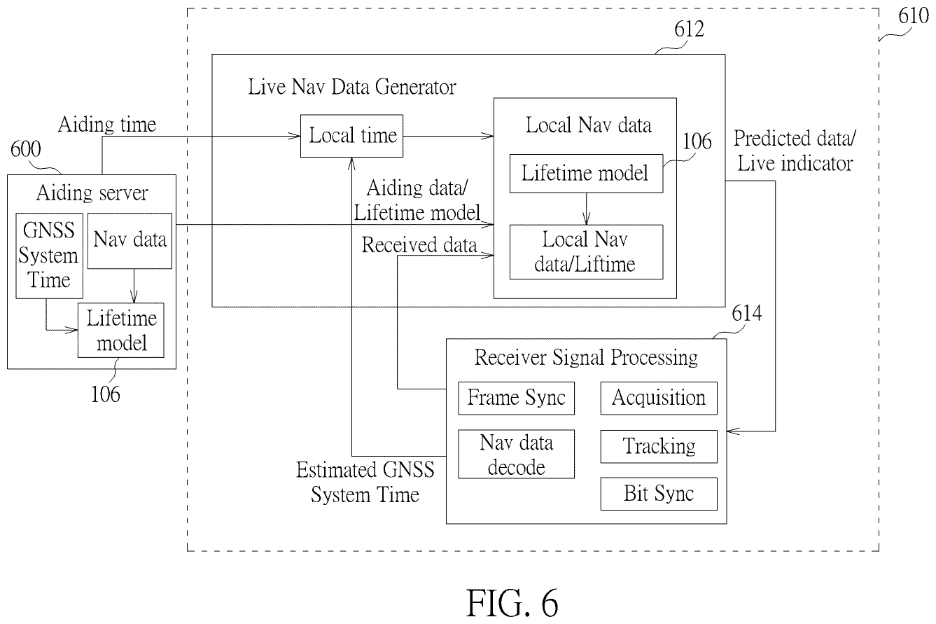

FIG. 6 is a diagram illustrating a second live navigation data generator design according to an embodiment of the present invention. In this embodiment, a live navigation data generator circuit (labeled by “Live Nav Data Generator”) 612 and a receiver signal processing circuit (labeled by “Receiver Signal Processing”) 614 are both implemented in an edge device 610. For example, the edge device 610 may be a portable device (e.g., smartphone, wearable device, or tablet) or an in-vehicle device. The edge device 610 can communicate with an aiding server 600. For example, the aiding server 600 is a cloud server such as an AGNSS server. The aiding server (e.g., AGNSS server) 600 may be a network-based system that provides aiding data (or aiding data and time) to GNSS receivers to improve their performance, especially in challenging environments like urban areas or indoors. For example, the aiding server (e.g., AGNSS server) 600 may regularly receive and store GNSS navigation data, where the GNSS navigation data are gathered from reference stations with clear satellite visibility. The receiver signal processing circuit 614 may be a part of a GNSS receiver. The aiding server (e.g., AGNSS server) 600 may include the electronic device 100 shown in FIG. 1. In other words, the aiding server (e.g., AGNSS server) 600 is capable of analyzing the GNSS navigation data D_{NAV} to learn the lifetime model 106. For example, the GNSS navigation data D_{NAV} include the navigation data locally maintained by the aiding server (e.g., AGNSS server) 600, and local synchronized GNSS system time maintained by the aiding server (e.g., AGNSS server) 600.

In some embodiments of the present invention, the live navigation data generator circuit 612 obtains the lifetime model 106 transmitted from the aiding server (e.g., AGNSS server) 600, and the edge device 610 uses the cloud version of the lifetime model 106 to assist the receiver signal processing circuit 614 in one or more GNSS processing functions (e.g., frame synchronization, navigation data decoding, acquisition, bit synchronization, carrier recovery, and timing recovery).

In some embodiments of the present invention, the live navigation data generator circuit 612 obtains the lifetime model 106 transmitted from the aiding server (e.g., AGNSS server) 600, and is equipped with another electronic device 100 shown in FIG. 1 to support a function of locally updating the cloud version of the lifetime model 106 through analyzing the GNSS navigation data D_{NAV}. The edge device 610 uses the updated cloud version of the lifetime model 106 to assist the receiver signal processing circuit 614 in one or more GNSS processing functions (e.g., frame synchronization, navigation data decoding, acquisition, bit synchronization, carrier recovery, and timing recovery).

In some embodiments of the present invention, the live navigation data generator circuit 612 obtains the lifetime model 106 transmitted from the aiding server (e.g., AGNSS server) 600, and is equipped with another electronic device 100 shown in FIG. 1 to support a function of learning a local version of the lifetime model 106. The edge device 610 can select one of the cloud version and the local version of the lifetime model 106 to assist the receiver signal processing circuit 614 in one or more GNSS processing functions (e.g., frame synchronization, navigation data decoding, acquisition, bit synchronization, carrier recovery, and timing recovery).

Consider a case where the live navigation data generator circuit 612 is also equipped with the electronic device 100 shown in FIG. 1 to support a function of locally learning/updating the lifetime model 106. The GNSS navigation data D_{NAV} may be obtained from one or more sources. The GNSS system time may be obtained from one or more sources.

In some embodiments of the present invention, the live navigation data generator circuit 612 equipped with the lifetime model learning capability obtains the GNSS navigation data D_{NAV} from the receive signal processing circuit 614. Specifically, the edge device 610 may receive at least a portion (i.e., part of all) of the GNSS navigation data D_{NAV} transmitted from at least one satellite.

In some embodiments of the present invention, the live navigation data generator circuit 612 equipped with the lifetime model learning capability obtains the GNSS navigation data D_{NAV} from the aiding server 600. Specifically, the edge device 610 may receive at least a portion (i.e., part or all) of the GNSS navigation data D_{NAV} from a cloud server.

In some embodiments of the present invention, the live navigation data generator circuit 612 equipped with the lifetime model learning capability obtains the GNSS navigation data D_{NAV} from the receive signal processing circuit 614 and the aiding server 600. Specifically, the edge device 610 may receive a first part of the GNSS navigation data D_{NAV} transmitted from at least one satellite, and may further receive a second part of the GNSS navigation data D_{NAV} from a cloud server. For example, the first part and the second part of the GNSS navigation data D_{NAV} (e.g., received data and aiding data) that are provided from different sources may be fused and then used for locally learning/updating the lifetime model 106.

In some embodiments of the present invention, the live navigation data generator circuit 612 equipped with the lifetime model learning capability obtains the GNSS system time from the receiver signal processing circuit 614. Specifically, the edge device 610 estimates at least a portion (i.e., part or all, such as time in a week or time in a second) of the GNSS system time.

In some embodiments of the present invention, the live navigation data generator circuit 612 equipped with the lifetime model learning capability obtains the GNSS system time (e.g., aiding time) from the aiding server 600. Specifically, the edge device 610 may receive at least a portion (i.e., part or all) of the GNSS system time from a cloud server.

In some embodiments of the present invention, the live navigation data generator circuit 612 equipped with the lifetime model learning capability obtains the GNSS system time from the receiver signal processing circuit 614 and the aiding server 600. Specifically, the edge device 610 may fuse the estimated GNSS system time from received signal and the aiding GNSS system time from the server to use or learn the lifetime model 106.

After a lifetime model is learned, the electronic device 100 needs to detect any unexpected changepoints and the new navigation data in the next lifetime period. The electronic device 100 is capable of analyzing the GNSS navigation data D_{NAV} to detect unexpected changepoints and update the lifetime model 106. In some embodiments of the present invention, the electronic device 100 may perform a lifetime model learning operation regularly. In other words, the electronic device 100 is capable of sampling the navigation data from Internet or satellites and updating the lifetime model 106 if necessary.

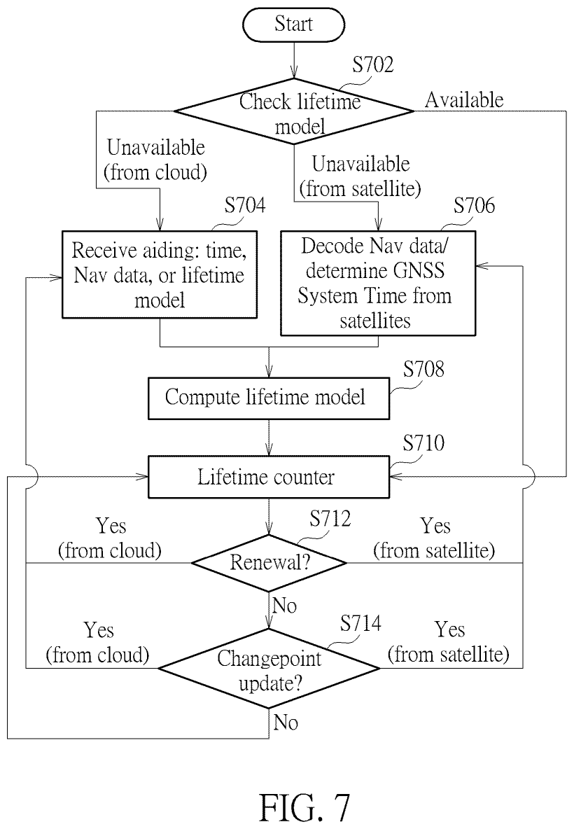

FIG. 7 is a flowchart illustrating a method of learning and updating a lifetime model of GNSS navigation messages according to an embodiment of the present invention. Provided that the result is substantially the same, the steps are not required to be executed in the exact order shown in FIG. 7. The method may be performed by the edge device 500/610 equipped with the lifetime model learning capability. In step S702, the edge device 500/610 checks if the lifetime model 106 is available. If the lifetime model 106 is not available yet, the edge device 500/610 obtains the GNSS navigation data G_{NAV} (step S704 or step S706), and analyzes the GNSS navigation data G_{NAV} to compute an initial version of the lifetime model 106 (step S708). In step S710, the edge device 500/610 starts a lifetime counter to count a lifetime period indicated by the lifetime model 106.

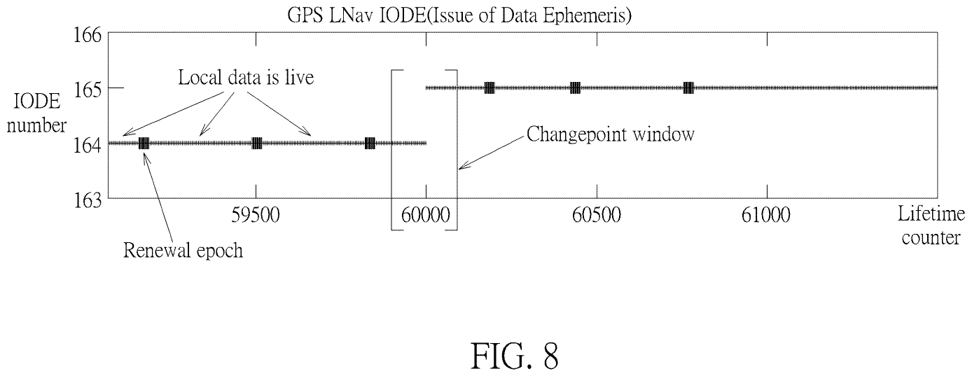

In step S712, the edge device 500/610 checks if the navigation data in the current lifetime period of the lifetime model 106 should be updated. If it is determined that the lifetime is overdue or to be overdue at this moment, the edge device 500/610 obtains new GNSS navigation data G_{NAV} (step S704 or step S706), and analyzes the GNSS navigation data G_{NAV} to compute an updated version of the lifetime model 106 (step S708). In step S714, the edge device 500/610 checks whether it is time to sample the GNSS navigation data and check any unexpected changepoints in the lifetime model 106. If the lifetime counter hits the predefined threshold, the edge dive 500/610 is asked to obtain the current navigation data (e.g., one subframe) and compare with the local data in the lifetime model 106 to detect any unexpected changepoint. FIG. 8 is a diagram illustrating an operation of sampling the data and updating the lifetime model 106 according to an embodiment of the present invention. The edge device 500/610 samples the data to detect and update the lifetime model 106 regularly, where the sampling frequency (or detection frequency) may be programmed to meet the low-power requirements. If the lifetime model 106 must be updated at this moment, the edge device 500/610 obtains new GNSS navigation data G_{NAV} (step S704 or step S706), and analyzes the GNSS navigation data G_{NAV} to compute an updated version of the lifetime model 106 (step S708). If it is determined that the changepoint remains unchanged, the edge device 500/610 keeps checking the lifetime counter to determine whether to update the lifetime model 106 (steps S710 and S712).

The lifetime model 106 includes information indicative of the relationship between GNSS system time (or local time) and changepoint of data content. The navigation data changes as the GNSS system time. In order to apply the predicted data bits to the current received data bits from the satellites, the Time of Arrival (TOA) of the data bits is required. TOA is equal to its transmitted GNSS system time from the satellite plus the propagation time (i.e., the time it takes for a signal to travel from a satellite to a GNSS receiver). The receiver must estimate TOA of the satellite signal and predict the corresponding data bits to process the received signals. The propagation time depends on the position of a satellite relative to the GNSS receiver, and it is known after the positioning fix. Or the receiver can estimate satellites' TOA based on the estimated current GNSS system time, receiver's position, and the satellites' position. These data can be obtained from AGNSS aiding data or historic receiver processing. The receiver signal processing circuit 504/614 included in the GNSS receiver may estimate the current GNSS system time according to historic data (e.g., previous positioning fixes), and synchronize the local time of the edge device 500/610 to the estimated GNSS system time. Moreover, the estimated GNSS system time from one satellite can be shared when the edge device 500/610 learns or uses lifetime models of GNSS navigation messages of all satellites. The edge device 500/610 may further estimate TOA of satellite data, and determine whether the data bits predicted by the lifetime model 106 are valid or not according to the estimated TOA. That is, the data is to be changed at a specified TOA epoch according to the learned lifetime model and the distance between the satellite and the receiver. Since a changepoint suffers uncertainty due to the TOA uncertainty range, the edge device 500/610 may consider the TOA uncertainty range when using or updating the lifetime model 106. It should be noted that, after fixing the receiver position, the edge device 500/610 may synchronize its local time to the true GNSS system time with minimum uncertainty, and can know the propagation time from the receiver position and the satellite's ephemeris/almanac.

In some embodiments of the present invention, the lifetime model 106 may be estimated using a single model approach.

Specifically, the GNSS navigation data D_{NAV} involved in learning of the lifetime model 106 are derived from navigation messages transmitted by a single signal from a single satellite.

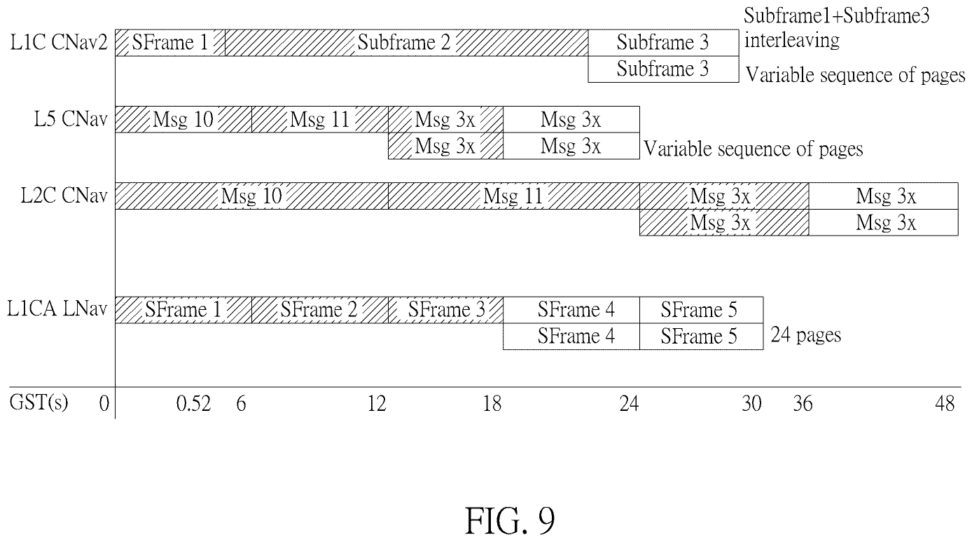

In some embodiments of the present invention, the lifetime model 106 may be estimated using a joint model approach. For example, the GNSS navigation data D_{NAV} involved in learning of the lifetime model 106 are derived from navigation messages transmitted by different signals from a single satellite, where all navigation messages are time synchronized. The same data (e.g., ephemeris data, time counter data, and status data) from different navigation messages broadcast by the same satellite can be jointly used by changepoint detection for learning the lifetime model. For example, a GPS satellite broadcasts 3 periodic navigation message streams, including LNav on L1CA/L2CA/L1 (Y), civil navigation message (CNav) on L2C/L5, and CNav2 on LIC, and leading edges of these navigation messages are aligned to the GPS System Time (GST), as illustrated in FIG. 9. The subframes marked by shaded areas in FIG. 9 are subframes that are needed by a positioning fix.

For another example, the GNSS navigation data D_{NAV} involved in learning of the lifetime model 106 are derived from navigation messages transmitted by different signals from different satellites, where data broadcasts of different satellites are time synchronized. The same data (e.g., almanac data, time counter data, and data structure index) from different navigation messages broadcast by different satellites can be jointly used by changepoint detection for learning the lifetime model. Some possible navigation messages that may be used by the joint model approach are listed in the following table. It should be noted that navigation messages from satellite signals of other GNSS systems (e.g., SBAS and NavIC) may also be used by the joint model approach.

TABLE 1

| GNSS | Navigation Message | Signal |
|---|---|---|
| GPS/QZSS | LNav | L1 C/A, L2 C/A |
| | CNav | L5, L2C |
| | CNav2 | L1C |
| GLONASS | Nav-Msg | L1OF |
| Galileo | INav | E1B, E5b |
| | FNav | E5a |
| BeiDou | D1 | B1I |
| | BCNav1 | B1C |
| | BCNav2 | B2a |
| | BCNav3 | B2b |

After the lifetime model is available to the edge device, the edge device can use the lifetime model to assist the GNSS receiver in one or more GNSS processing functions (e.g., frame synchronization, navigation data decoding, acquisition, bit synchronization, carrier recovery, and timing recovery). Because the GNSS navigation data message does not change quickly in most cases, the proposed lifetime model provides a predicted lifetime period of navigation data, and the GNSS receiver can use live local data, which is received previously and does not change after last changepoint, to achieve TTFF without receiving the data from satellites or an AGSS server. Moreover, the live local data can aid and enhance performance of the other receiver signal processing functions. For example, quick frame synchronization can be achieved with data aiding.

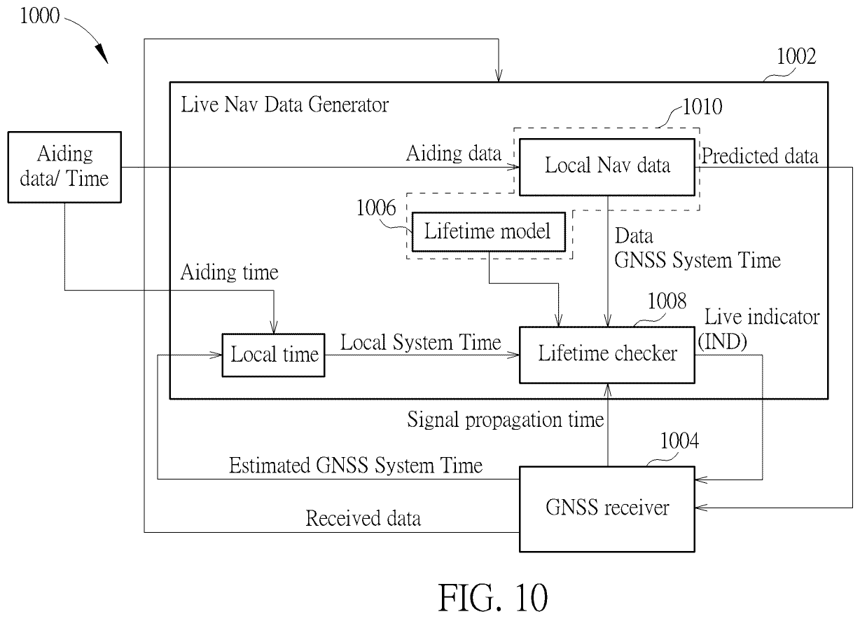

FIG. 10 is a diagram illustrating an edge device for performing a lifetime model aided GNSS signal processing function according to an embodiment of the present invention. The edge device 1000 includes a live navigation data generator circuit (labeled by “Live Nav Data Generator”) 1002 and a GNSS receiver 1004. For example, the edge device 1000 may be a portable device (e.g., smartphone, wearable device, or tablet) or an in-vehicle device. The edge device 1000 can communicate with an aiding server (not shown) to obtain aiding data/time from the aiding server. The live navigation data generator circuit 1000 has a storage device (e.g., memory device) 1010 to store a lifetime model 1006 and local GNSS navigation data D_{Local} (which include one or more previous received GNSS navigation messages or the equivalent database). The lifetime model 1006 may be the lifetime model 106 that can be learned on the cloud server (e.g., AGNSS server) or the edge device (e.g., user device). The live navigation data generator circuit 1000 synchronizes its local time to the GNSS system time. The live navigation data generator circuit 1000 has a lifetime checking circuit (labeled by “Lifetime Checker”) 1008 to determine validity of the local GNSS navigation data according to lifetime period information provided from the lifetime model 1006. When the local GNSS navigation data D_{Local} is validated by the lifetime checking circuit 1008 using the lifetime model 1006, the lifetime checking circuit 1008 outputs a live indicator IND (e.g., IND=1) to the GNSS receiver 1004, and the GNSS receiver 1004 performs a GNSS signal processing function with the aid of the live local GNSS navigation data D_{Local}.

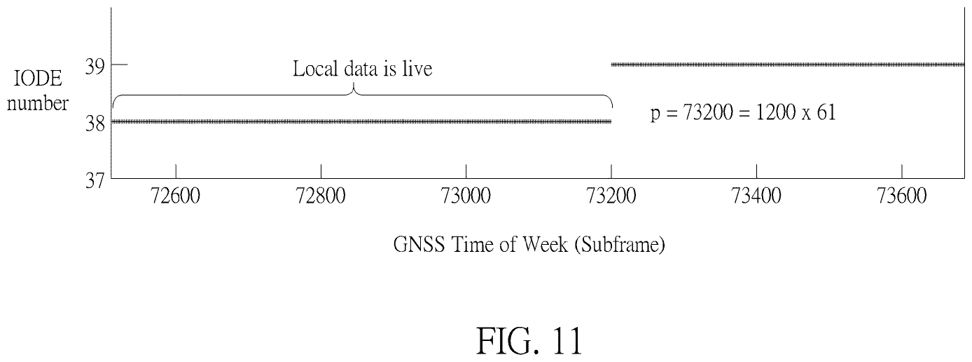

FIG. 11 is a diagram illustrating a scenario in which the local GNSS navigation data are used to aid the GNSS signal processing function according to an embodiment of the present invention. For example, the GPS LNav words W3-W10 of subframes 1-3 have changepoints at GPS system time, p=n*1200, where n={0, 1, 2, . . . } and p in units of subframes (6 seconds per subframe). Hence, before a next changepoint p (e.g., p=61*1200) occurs, the local GNSS navigation data D_{Local} (which include one or more previous received GNSS navigation messages or the equivalent database) do not change since the last changepoint p (e.g., p=60*1200).

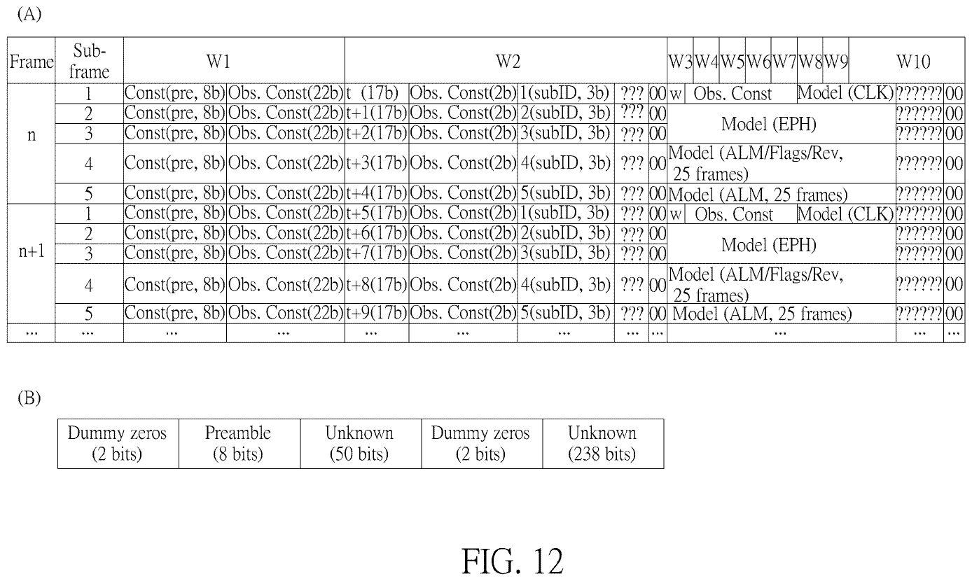

After bit synchronization for determining the bit boundary is completed, the GNSS receiver 1004 may perform a lifetime model aided frame synchronization function to search for the subframe boundary to decode the GNSS system time and/or the GNSS navigation data. Constant bits in subframes of the GNSS navigation message can be used to identify the subframe boundary. FIG. 12 is a diagram illustrating distribution of constant bits within each GPS LNav. Each subframe of one navigation message includes an 8-bit preamble (which consists of constant bits) in the first word W1, dummy zeros (2 bits) in the second word W2, and dummy zeros (2 bits) in the last word W10. Hence, a search pattern (i.e., local replica) may be set by a 12-bit pattern consisting of an 8-bit preamble and four dummy zeros, or may be set by a 10-bit pattern consisting of an 8-bit preamble and two dummy zeros. With the aid of the proposed lifetime model, a predicted lifetime period of the navigation data can be used to validate the local navigation data (which include one or more previous received navigation messages or the equivalent database). In this way, additional constant bits derived from the “Constant in Lifetime” data set can be added to the search pattern (i.e., local replica) when the frame synchronization is active during the predicted lifetime period. For example, when the frame synchronization function is active during the predicted lifetime period, a search pattern (i.e., local replica) may be set by a 36-bit pattern consisting of an 8-bit preamble, four dummy zeros, and 24-bit constant observed data in its lifetime period.

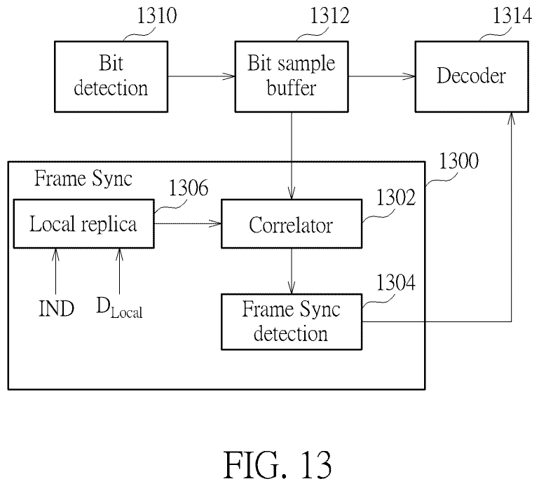

FIG. 13 is a diagram illustrating a frame synchronization circuit of a GNSS receiver according to an embodiment of the present invention. The frame synchronization circuit (labeled by “Frame Sync”) 1300 is configured to deal with a lifetime model aided frame synchronization function. In addition to the frame synchronization circuit 1300, the GNSS receiver further includes a bit detection circuit (labeled by “Bit Detection”) 1310, a bit sample buffer 1312, and a decoder 1314. The bit detection circuit 1310 refers to the bit boundary to obtain bit samples transmitted via the satellite signal, and sequentially stores the bit samples into the bit sample buffer 1312. For example, the bit sample may be a real number, such as a logic value (0 or 1), a hard decision value (1 or −1), or a soft decision value (−8, −7, . . . , 0, . . . , 7, or 8). For another example, the bit sample may be a complex number, if phase is not locked in the carrier recovery. The frame synchronization circuit 1300 determines which bit is the subframe beginning. Take the GPS LNav for example, one subframe has 300 bits, and the frame synchronization circuit 1300 adopts 300 hypotheses for identifying the subframe boundary.

The frame synchronization circuit 1300 includes a correlator 1302, a frame synchronization detector circuit (labeled by “Frame Sync Detection”) 1304, and a local replica 1306. The correlator 1302 is configured to generate a correlation result of each hypothesis between bit samples in the bit sample buffer 1312 and the local replica 1306. The frame synchronization circuit 1304 refers to hypothesis test results (i.e., correlation values) of different hypotheses to identify the subframe boundary. The decoder 1314 is configured to refer to the subframe boundary for applying navigation data decoding to bit samples stored in the bit sample buffer 1312.

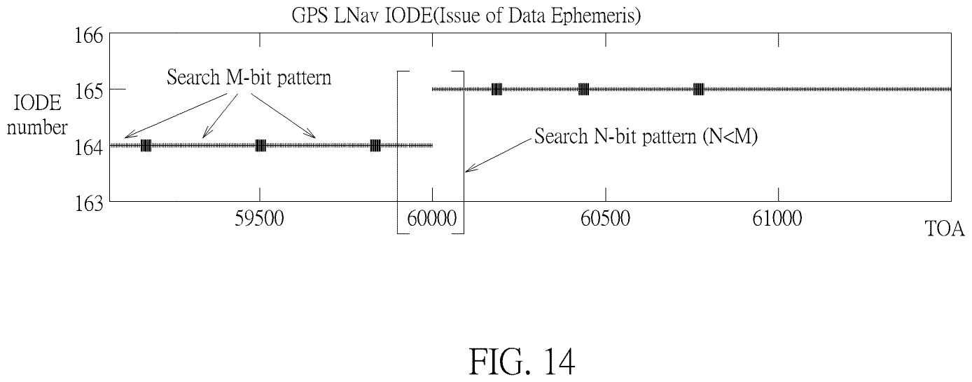

In this embodiment, the local replica 1306 used by a correlation operation for the frame synchronization is derived from the local GNSS navigation data D_{Local}. Specifically, the local replica 1306 includes bits of a data set of a GNSS navigation message (e.g., bits of a “Constant in Lifetime” data set included in a subframe) that are constant during a lifetime period indicated by the lifetime model and change after an end of the lifetime period. In addition, the size of the local replica 1306 may be adaptively adjusted according to the live indicator IND. FIG. 14 is a diagram illustrating a search pattern (i.e., local replica) with different sizes in different periods of the frame synchronization according to an embodiment of the present invention. During a lifetime period indicated by the lifetime model (e.g., IND=1), the correlator 1302 may use an M-bit pattern (e.g., M=36) as the local replica 1306, where the M-bit pattern may include an 8-bit preamble, 4 dummy zeros, and 24-bit constant observed data. During a changepoint window (e.g., IND=0), the lifetime period is uncertain, and the correlator 1302 may use an N-bit pattern (e.g., N=12) as the local replica 1306, where the N-bit pattern may include an 8-bit preamble and 4 dummy zeros.

As illustrated in sub-diagram (A) of FIG. 12, constant bits are repeated in all subframes. In some embodiments of the present invention, a repeated constant pattern (e.g., 12 bits in an uncertain live period, or 36 bits in a live period) in every subframe can be used to enhance the hypothesis test result signal-to-noise ratio (SNR).

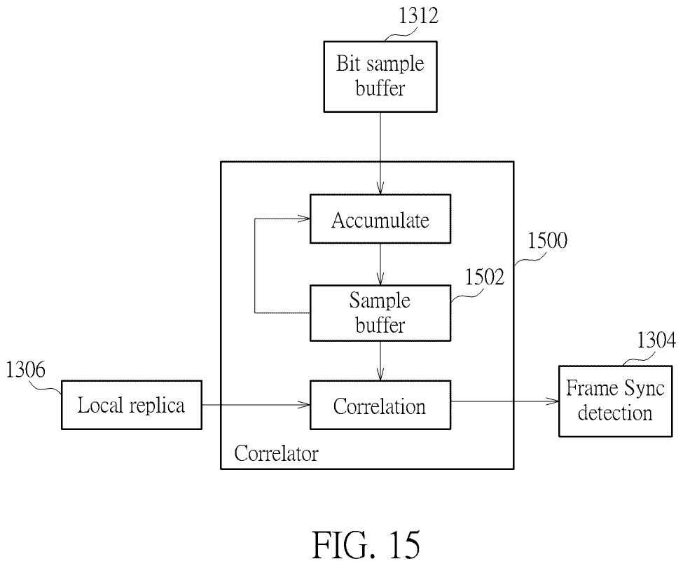

FIG. 15 is a diagram illustrating a first correlator design according to an embodiment of the present invention. The correlator 1302 shown in FIG. 13 may be implemented using the correlator 1500. The correlator 1500 is configured to perform accumulation before correlation. Specifically, the bit samples stored in the bit sample buffer 1312 include bit samples of a plurality of bit sequences of a same hypothesis, and the correlator 1302 accumulates bit samples of the plurality of bit sequences of the same hypothesis to generate and store a pre-correlation bit sequence into a sample buffer 1502, and performs a correlation operation upon the stored pre-correlation bit sequence according to the local replica 1306 to generate a correlation result of the hypothesis. For example, an i^{th} bit sample of the pre-correlation bit sequence is derived from accumulating i^{th} bit samples of the plurality of bit sequences. In a case where each bit sample is a logic value (0 or 1), accumulation of bit samples may use majority voting to determine the final 0/1 estimation. In another case where each bit sample is a hard decision value (real/complex number) or a soft decision value (real/complex number), accumulation of bit samples may output a sum of bit samples.

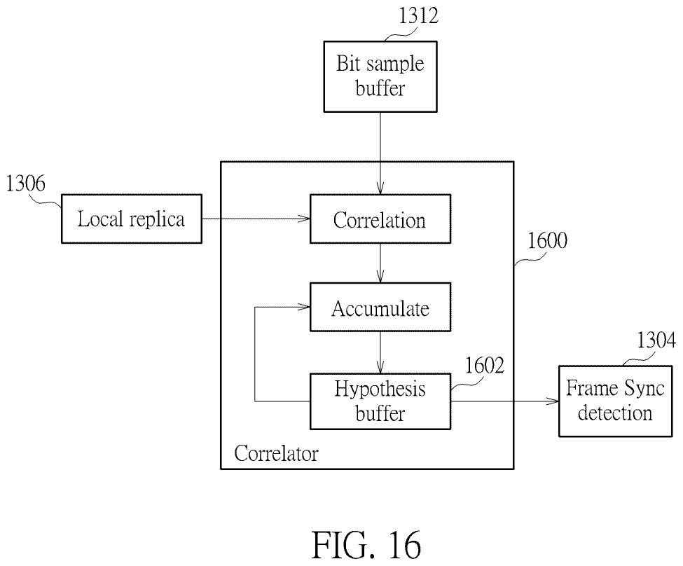

FIG. 16 is a diagram illustrating a second correlator design according to an embodiment of the present invention. The correlator 1302 shown in FIG. 13 may be implemented using the correlator 1600. The correlator 1600 is configured to perform accumulation after correlation. Specifically, the bit samples stored in the bit sample buffer 1312 include bit samples of a plurality of bit sequences of a same hypothesis, and the correlator 1600 performs a correlation operation upon each of the plurality of bit sequences of the same hypothesis according to the local replica 1306, to generate and store correlation results of the same hypothesis into a hypothesis buffer 1602, and accumulate the stored correlation results of the same hypothesis for generating a final correlation result of the same hypothesis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of learning a lifetime model of global navigation satellite system (GNSS) navigation messages comprising:
obtaining GNSS navigation data; and
analyzing the GNSS navigation data to learn the lifetime model, wherein the lifetime model comprises information indicative of a lifetime behavior of at least one data set of a GNSS navigation message.

2. The method of claim 1, wherein the GNSS navigation data comprise a sequence of received GNSS navigation messages; and analyzing the GNSS navigation data to learn the lifetime model comprises:
performing changepoint detection upon the sequence of received GNSS navigation messages.

3. The method of claim 1, wherein analyzing the GNSS navigation data to learn the lifetime model is performed by an edge device.

4. The method of claim 3, wherein obtaining the GNSS navigation data comprises:
receiving, by the edge device, at least a portion of the GNSS navigation data transmitted from at least one satellite.

5. The method of claim 3, wherein obtaining the GNSS navigation data comprises:
receiving, by the edge device, at least a portion of the GNSS navigation data from a cloud server.

6. The method of claim 3, wherein obtaining the GNSS navigation data comprises:
receiving, by the edge device, a first part of the GNSS navigation data transmitted from at least one satellite; and
receiving, by the edge device, a second part of the GNSS navigation data from a cloud server.

7. The method of claim 1, wherein analyzing the GNSS navigation data to learn the lifetime model is performed by a cloud server.

8. The method of claim 7, further comprising:
transmitting the lifetime model from the cloud server to an edge device.

9. The method of claim 1, further comprising:
calculating estimated GNSS system time; and
synchronizing local time to the estimated GNSS system time.

10. The method of claim 1, further comprising:
updating the lifetime model at different time instants.

11. The method of claim 10, wherein updating the lifetime model at different time instants comprises:
calculating a time counter; and
determining whether to obtain GNSS navigation data or/and time according to the time counter.

12. The method of claim 1, wherein the GNSS navigation data involved in learning of the lifetime model are derived from navigation messages transmitted by a single signal from a single satellite.

13. The method of claim 1, wherein the GNSS navigation data involved in learning of the lifetime model are derived from navigation messages transmitted by different signals from a single satellite.

14. The method of claim 1, wherein the GNSS navigation data involved in learning of the lifetime model are derived from navigation messages transmitted by different signals from different satellites.

15. A lifetime model aided global navigation satellite system (GNSS)
signal processing method comprising:
storing local GNSS navigation data;
maintaining a lifetime model of GNSS navigation messages, wherein the lifetime model comprises information indicative of a lifetime behavior of at least one data set of a GNSS navigation message;
determining validity of the local GNSS navigation data according to the lifetime model; and
in response to the local GNSS navigation data being validated by using the lifetime model, performing a GNSS signal processing function with the aid of the local GNSS navigation data.

16. The lifetime model aided GNSS signal processing method of claim 15, wherein determining the validity of the local GNSS navigation data according to the lifetime model comprises:
estimating, by an edge device, a time of arrival of a satellite signal; and
comparing the time of arrival with a changepoint of signal in the lifetime model.

17. The lifetime model aided GNSS signal processing method of claim 16, wherein estimating, by the edge device, the time of arrival of the satellite signal comprises:
estimating current GNSS system time from a received satellite signal, a cloud server, or historic data;
estimating current satellite's position from the received satellite signal, the cloud server, or the historic data;
estimating current receiver's position from the received satellite signal, the cloud server, or the historic data; and
computing the time of arrival from the estimated current GNSS system time, the estimated current receiver's position and the estimated current satellite's position.

18. The lifetime model aided GNSS signal processing method of claim 15, wherein the GNSS signal processing function is frame synchronization, and a local replica used by a correlation operation for the frame synchronization includes bits of a data set of a GNSS navigation message that are constant during a lifetime period indicated by the lifetime model and change after an end of the lifetime period.

19. The lifetime model aided GNSS signal processing method of claim 15, wherein performing the GNSS signal processing function with the aid of the local GNSS navigation data comprises:
accumulating bit samples of a plurality of bit sequences of a hypothesis to generate a pre-correlation bit sequence, and performing the correlation operation upon the pre-correlation bit sequence according to the local replica to generate a correlation result of the hypothesis; or
performing the correlation operation upon each of the plurality of bit sequences of the hypothesis according to the local replica, to generate a plurality of correlation results of the hypothesis, and accumulating the plurality of correlation results of the hypothesis to generate a final correlation result of the hypothesis.

20. An electronic device comprising:
a storage device; and
a processing circuit, configured to obtain global navigation satellite system (GNSS) navigation data, analyze the GNSS navigation data to learn a lifetime model of GNSS navigation messages, and store the lifetime model in the storage device, wherein the lifetime model comprises information indicative of a lifetime behavior of at least one data set of a GNSS navigation message.
